(19) United States
(12) Patent Application Publication
(10) Pub. No.: US 2003/0123478 A1
(43) Pub. Date: Jul. 3, 2003

(54) Method and system for recording conversation

(76) Inventor: Omry Paiss, Bet Dagan (IL)

Correspondence Address: Eitan, Pearl, Latzer & Cohen-Zedek, LLP, 10 Rockerfeller Plaza, Suite 1001, New York, NY, 10020, US

(21) Appl. No.: 10/026,678

(22) Filed: Dec. 27, 2001

(51) Int. Cl. H04Q 7/00; H04J 3/16

(52) U.S. Cl. 370/466; 370/328

(57) ABSTRACT

Briefly, in accordance with one embodiment of the invention, a server and a system for recording and playing conversations of a wireless communication system are provided. A service for recording conversation between two or more subscribers of a hybrid communication system is also provided.

### BACKGROUND

Hybrid communication systems may be a combination of two or more communication systems. A hybrid communication system may include for example, a computer communication network, wireless communication systems and wired communication systems. A communication system of a hybrid communication system may employ a recording service. The recording service may record conversations between subscribers of the substantially equal communication systems. Furthermore, the recording of conversations may be controlled by the communication system operator and the recording service is not provided to subscribers.

A remote station of the communication system may include the operation of recording voice memos. This operation is limited to the size of an internal memory of the remote station. Furthermore, the remote station may not enable the subscriber to record a conversation with other subscribers.

Thus, there is need for providing a service and a server for recording conversations between remote stations of the hybrid communication system which are not limited by the size of the memory of the remote station.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram of a hybrid communication system in accordance with an embodiment the present invention;

FIG. 2 is a block diagram of a server of a wireless communication system that may be used in accordance with the present invention; and

FIGS. 3, 4 and 5 are flowcharts illustrating examples of methods to provide services in accordance with the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

It should be understood that the present invention may be used in variety of applications. Furthermore, the present invention may be used with any wireless communication system. Although the present invention is not limited in this respect, the circuits and techniques disclosed herein may be used in many apparatuses such as servers of a wireless communication system. Servers intended to be included within the scope of the present invention may be included, by a way of example only, within cellular systems, two-way radio systems, digital radio systems and the like.

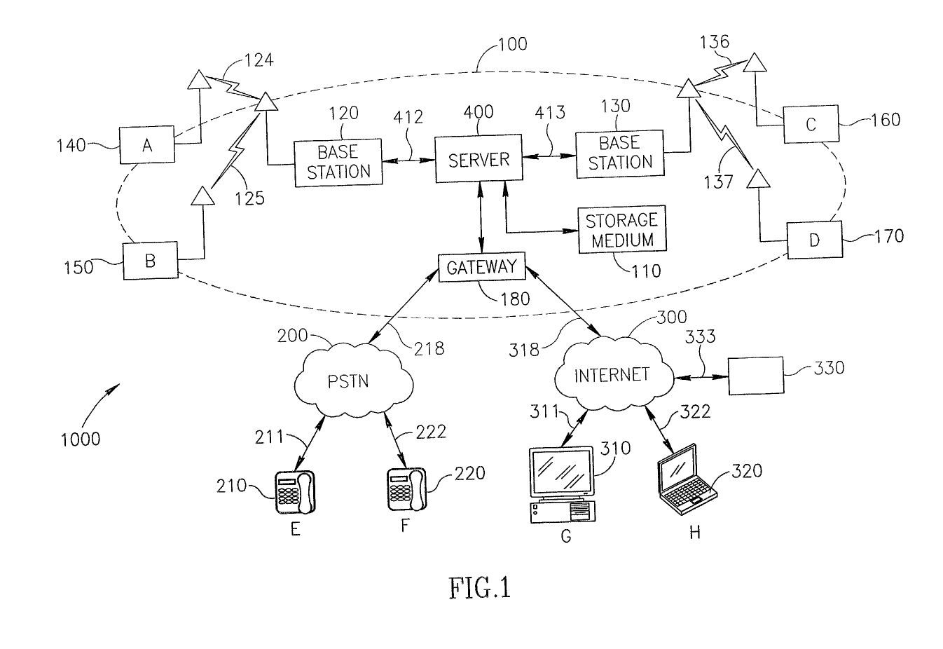

Turning first to FIG. 1, a hybrid communication system 1000 in accordance with an embodiment of the invention is shown. Although the scope of the present invention is not limited in this respect, hybrid communication system 1000 may comprise a wireless communication system 100, for example a cellular communication system, a public switched telephony network (PSTN) 200 and a global network 300 or the Internet.

Although the scope of the present invention is not limited to this example, communication channels are used to transfer data packets to the devices of the communication system. Communication channels may include one or more links to transfer the data packets. For example, one link may be used to transfer data packets from a remote station to a base station and other link may be used to transfer data packets from the base station to the remote station, if desired. Furthermore, links may be used to transfer analog signals such as voice and video. Although the scope of the present invention is not limited in this respect, in wireless communication art, the terms “uplink” and “downlink” may be used by one skilled in the art. The downlink may be the link to transfer data packets from the remote station to the base station and the uplink may be may be the link to transfer data packets from the base station to the remote station. Furthermore, links may be used to broadcast communications between devices of communication system and/or between communication systems. In addition, a link may be combined from links of two or more communication channels and may employ data packets of a single conversation.

Although the scope of the present invention is not limited to this example, the wireless communication system 100 may include a server 400 which may be adapted to record conversations over the wireless communication system 100, a storage medium 110 for example a hard disk, a base station 120, a base station 130, a remote station A 140, a remote station B 150, a remote station C 160, a remote station D 170 and a gateway 180. Although the scope of the present invention is not limited in this respect, the remote stations may be personal communication devices, cellular mobile phones, wireless phones, mobile communication assistances (PCA) and alike. Communication channels 124, 125, 136, 137 may be used to transfer data packets comprising media content of the conversation between the remote stations 140, 150, 160, 170 to base stations 120, 130. Communication channels 124, 125, 136, 137 may include an uplink and a downlink. Communication channel 124 may be used to transfer data packets between remote station A 140 to base station 120 and vice versa. Communication channel 125 may be used to transfer packets between remote station B 150 to the base station 120 and vice versa. The communication channel 136 may be used to transfer data packets between remote station C 160 to the base station 130 and vice versa and the communication channel 137 may be used to transfer data packets between remote station D 170 to the base station 130 and vice versa. Although the scope of the present invention is not limited to these examples, the wireless communication system 100 may be any wireless communication system such as cellular communication system, two way digital wireless communication system, satellite communication system or alike.

Although the scope of the present invention is not limited in this respect, the PSTN 200 may include a remote station E 210 and a remote station F 220, which may be, for example, telephones. The PSTN 200, if desired, may further include a speech converter (not shown) which may convert the voice from remote stations 210, 220 into data packets. However, in an alternative embodiment of the invention, the gateway 180 may include a speech converter (not shown) or other types of media converters that may convert media stream between PSTN 200 and the Internet to the wireless communication system 100 into data packets. The data packets may be converted to the format of the data packets of the wireless communication system 100. In addition, the PSTN 200 may comprise communication channels 211, 222 and 218, if desired. For example, communication channels 211 and 222 may include one or more links to transfer voice from the telephones 210, 222 to the PSTN infrastructure, and communication channel 218 may include one or more links to transfer voice and/or data packets to gateway 180 and vice versa. Although the scope of the present invention is not limited in this respect, the data packets may be adapted to data packets of an Internet Protocol (IP), Real-Time Transport Protocol (RTP) or alike. Media content may include a digital representation of voice samples, if desired.

Furthermore, the global network 300, for example the Internet, may include a remote station G 310, for example a personal computer, a remote station H 320, for example a laptop computer, and a mail server 330. Communication channels 311, 322, 333 may include one or more links to transfer data packets from remote stations 310, 320, 330 to the gateway 180 through communication channel 318 and vice versa.

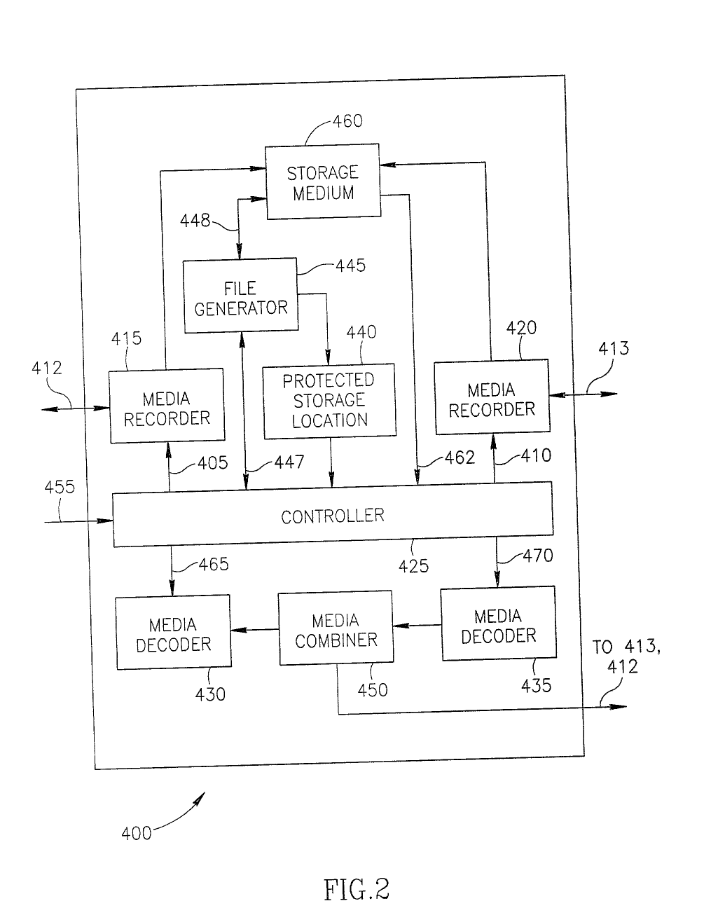

Referring now to FIG. 2, the server 400 according to an embodiment of the present invention is shown. Although it should be understood that the scope and application of the present invention is in no way limited to this example, the server 400 may include a media recorder 415, a media recorder 420, a controller 425, a media decoder 430, a media decoder 435, a protected storage location 440, a file generator 445, a media combiner 450 and a storage medium 460. However, it should be understood that the scope of the present invention is not limited by the inclusion or exclusion of such components.

In operation, the controller 425 may receive a command, for example, “Record a voice conversation between remote stations A and C, 140, 160”. Although the scope of the present invention is not limited in this respect, the command may be provided by a communication protocol. The command may be composed from a sequence of binary codes. A new command may be generated by providing a different sequence of binary codes. Furthermore, the command may be a computer-language-like command which may be executed by an operating system of the remote system, if desired. Although the scope of the present invention is not limited in this respect, the command may be in the format of any communication protocol known in the art or a part of such protocol, if desired. However, any digital representation of the command that may be sent over the communication channels by data packets may be used.

In response to the command, the server 400 may record data packets of the conversation. Data packets may be transferred via links 412, 413. The media recorders 415, 420 may record the conversation by alternating between the links 412, 413. Furthermore, the media recorders 415, 420 may store the media content of the conversation at the storage medium 460. Additionally, the controller 425 may command the file generator 445 to generate a file which includes the recorded media content of the conversation from links 412, 413.

In response, the file generator 445 may command the controller to alternate between the media recorders 415, 420 for recording the conversation. In addition, the controller 425 may combine the decoded media from the media decoders 465, 470 into a file. In this example, the file generator 445 may command the controller 425 to receive the recorded media content through line 447. However, in other embodiments of the present invention, the file generator 445 may be connected to the media recorders 415, 420. Furthermore, the file generator 445 may download the recorded media content of the conversion from the storage media 460, as is shown with line 448. Although the scope of the present invention is not limited to this example, the file format may be such as Motion Picture Experts Group—Audio Layer 3 (MP3), Moving Pictures Experts Group (MPEG) and the like. The file may be stored at the protected storage location 440 such as a file server, mailbox, media mailbox or the like. Although the scope of the present invention is not limited to this respect, the media recorders 415, 420 may comprise a digital recorder that may be adapted to record types of media such as voice, video, text and animation, if desired. The storage medium 460 may include, for example, a hard drive, a magnetic type, a Flash memory, a laser disk or the like. In addition, the alternating between the links 412, 413 may be done, for example, by the controller 425. In this embodiment of the invention, the controller 425 may control the operation of the media recorders 415, 420 through command lines 405, 410 respectively. The controller 425 may control the media recorders 415, 420 to record the media content of the conversation according to a predetermined sequence, for example, recording 10 milliseconds of media content by media recorder 415 and recording 10 milliseconds of media content by media recorder 420. However, it should be understood to one skilled in the art that the present invention is not limited to this embodiment, and alternative embodiments that comprise switches which may be adapted to switch between links 412, 413 may be used, if desired.

Although the scope of the present invention is not limited in this respect, the controller 425 may receive a command from one of the remote stations, for example remote station B 150, to send the recorded conversation content to a subscriber. The command may be received over command line 455 as shown. Although the scope of the present invention is not limited in this respect, the subscriber may have a subscription to the conversation recording service of the wireless communication system. The subscriber may use any of the remote stations 140, 150, 160, 170, 210, 220, 310, 320, 330 to initiate a recording command. Furthermore, the subscriber may be an originator of the recording and the owner of the recorded conversation which was initiated by himself. The subscriber may generate, store, delete, download and send the media content of the recorded conversation. In addition, subscriber may have privileges in a recorded conversation which was not originated by himself. An example of sending the recorded conversation to remote station B 150 will now be described.

Although the scope of the present invention is not limited in this respect, remote station B 150 may send a command to server 400 to receive a recorded conversation, for example, a conversation that has been recorded between remote stations B and D 150, 170. The controller 425 may search the storage medium 460 for the requested recorded media content of the conversation (line 462). For example, the storage medium may comprise a database which supports Structured Query Language (SQL), and the controller 425 may use an SQL software tool to search the database. However it should be understood that the scope and application of the present invention is in no way limited to these examples, and other types of databases and search tools may be used. Additionally, the controller 425 may retrieve the recorded conversation through line 462. The controller 425 may decode the conversation by alternating between decoders 430, 435. The media combiner 450 may combine the decoded media content of the conversation and encode it to data packets. The data packets may be sent to remote station B 150 through link 412. Furthermore, alternating between the media decoders 430, 435 may be done by command lines 465, 470 respectively. The controller 425 may use substantially equal alternating sequences for the alternating sequence that was used to record the conversation and for the alternating sequence that was used to decode the recorded conversation. However, in alternative embodiments of the present invention, at least one switch may be used to switch between the decoders 430 and 435. In addition, the recorded conversation may be retrieved by remote stations of other communication networks. In the example below, a description of retrieving the recorded conversion through the Internet 300 and by the remote station G 310, e.g. a personal computer (PC), is provided.

Although the scope of the present invention is not limited in this respect, the remote station G 310, e.g. PC, may send a command over communication channels 311, 318 through Internet 300 and gateway 180 to server 400. The command may be, for example, to send a file which includes media content of the recorded conversation between remote stations D 170, and E 210, e.g. telephone. Gateway 180 may connect the wireless communication system 100 to the global network, e.g. Internet 300. Server 400 may send the requested file to mailbox 330 or may authorize PC 310 to download the file from protected storage location 440. PC 310 may play the file by alternating between two or more media decoders at the substantially equal alternating sequence in which the conversation was recorded. Media decoders may be included with the PC 310. Alternatively, PC 310 may receive a decoded media stream and play the conversation by using a media player application. In this case, the decoding may be done by alternating between media decoders 430, 435 at a substantially equal sequence to the sequence that the conversation was recorded at the server 400, if desired. Alternatively and additionally, the PC 310 may extract the file from a mail message and play the file by alternating between two or more media decoders according to a substantially equal sequence to the sequence that the conversation has been recorded. The mail message may be stored at mailbox 330.

Turning now to FIG. 3 a flowchart of a service for recording a conversation between remote stations of wireless communication system according to an embodiment of the invention is shown.

Although the scope of the present invention is not limited in this respect, the recording may start by dialing, from the remote station C 160, an accessing code for example, “*500”, as is shown in block 510. The transportation, e.g. data packets, from communication channel 136 to remote station C 160 may be recorded by the server 400. The subscriber, which may be the recording originator, may dial to any remote station with whom the subscriber wishes to record the conversation, for example remote station A 140, as is shown in block 512. The conversation, e.g. data packets, between remote stations A 140, C 160 may be recorded by server 400 by alternating between media recorders 415, 420 that are in operation with the links of communication channels 124, 136 respectively (FIG. 1). Data packets comprising the media content of a conversation over communication channels 124, 136 may be stored at storage medium 460 (FIG. 2). Recording of the conversation may be ended by hanging up the conversation, block 514. In an alternative embodiment of the present invention the recording of the conversation may be stopped by dialing an access code, for example “*501”, by the subscriber of remote station C 160. In addition, subscriber may use the recording service to turn the remote station, e.g. personal communication assistance (PCA) into a recording device. In this case, the content of the recording may be stored at protected media storage 440.

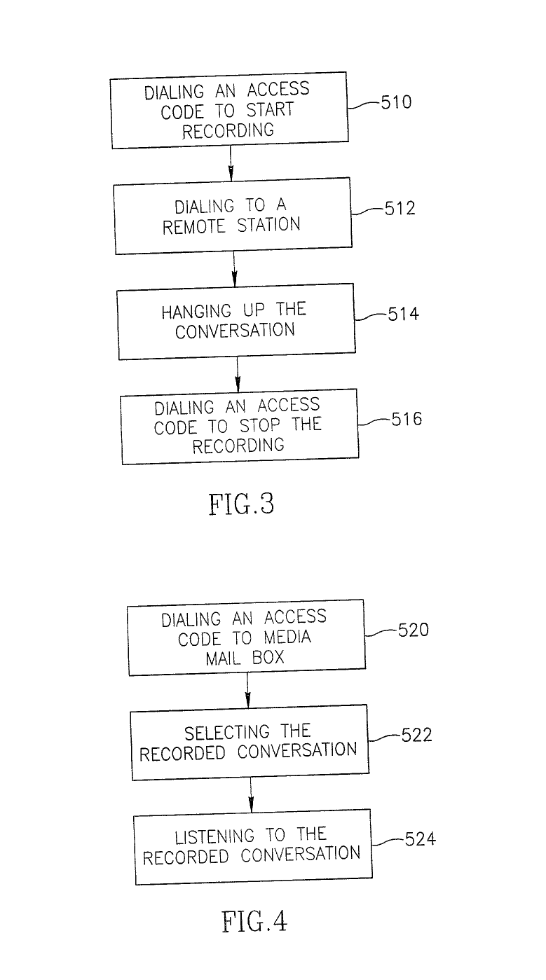

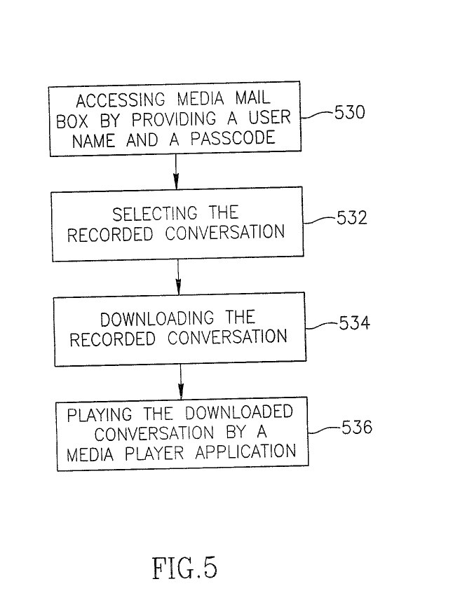

Turning now to FIG. 4, an example of a flowchart of playing the recorded conversation by a wireless remote station or a telephone according to an embodiment of the invention is shown.

Although the scope of the present invention is not limited in this respect, subscriber of remote station C 160, which may be the recording originator, may send a command to the server to play the recorded media content of the conversation. For example, the subscribe may dial an access code, for example “*502”, to a media mailbox which may be located at the server 400, e.g. protected storage location 440 of FIG. 2, as is shown in block 520. The media mailbox may be provided to subscribers of the service and may be adapted to store the recorded media content. In addition, the media mailbox may provide the stored media content to the subscriber. Furthermore, the subscriber, which may be the recording originator, may select the recorded conversation by pressing buttons on the telephone or mobile station keypad, (block 522) and listening to the recorded conversation (block 524). The server 400 may combine the recorded media content, as described with FIG. 2 above. Server 400 may send the encoded media content of the selected conversation to a commanding remote station, for example remote station C 160, e.g. wireless remote station, or remote station H 210, e.g. telephone.

Turning to FIG. 5, an example of a flowchart of playing the recorded conversation by a computer according to an embodiment of the invention is shown.

Although the scope of the present invention is not limited in this respect, the subscriber may enter to the home page of the service from remote station G 310, e.g. a PC. At the home page, the subscriber may provide user name and passcode, as is shown in block 530. Hence, the subscribe may enter to the service site and select the recorded conversation file, block 532. For example, the selected file of the conversation may be generated by file generator 445 and may be stored at protected storage location 440 (FIG. 2). Subscriber may download the selected file to the computer, e.g. remote station G 310 or remote station H 320, and play the file by alternating between two or more media decoders of the computer, as is shown in blocks 534, 535.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed is:

1. A method comprising:
sending data packets of a recorded conversation to a subscriber, wherein a conversion recording is done by alternating between a first link and a second link of a communication system to record a conversation.

2. The method of claim 1, wherein the conversation recording comprises:
decoding a recorded media content of the recorded conversation by alternating between a first media decoder to a second media decoder; and
storing data packets comprising the recorded media content of the recorded conversation in a storage medium.

3. The method of claim 2, further comprising:
generating a file that includes the data packets comprising the recorded media content of the recorded conversation; and
storing the file at a secured location having a controlled access.

4. The method of claim 3 further comprising:
receiving a command for sending the file via a global network to a computer.

5. The method of claim 3 comprising:
receiving a command for sending the file to the remote station via the wireless communication system; and
generating the file by decoding the stored packets by alternating between the first media decoder to the second media decoder and combining the decoded packets.

6. A wireless communication system comprising:
a server to record data packets comprising a media content of a first link and a second link of a conversation by alternating between the first link to the second link and storing recorded data packets at a storage medium; and
a remote station to send a command to receive the recorded packets of the conversation.

7. The system of claim 6, wherein the server comprises:
a file generator to generate a file which includes a recorded media content of the first link and the second link by alternating between a first media decoder to a second media decoder and combining the decoded media from the first and second media decoders to the file; and
a secured storage location having a controlled accesses to store the file.

8. The system of claim 7, wherein the secured storage location is a media mailbox.

9. The system of claim 8 further comprising:
a gateway to connect the wireless communication system to a global network; and
a computer operably coupled to the global network to play the file via the global network by alternating between the first media decoder to the second media decoder.

10. The system of claim 6, wherein the remote station is a personal communication assistant (PCA).

11. An apparatus comprising:
a media recorder to record data packets comprising a media content of a first link and a second link of a conversation by alternating between the links;
a storage medium to store the data packets; and
a first and a second media decoders to decode a recorded media.

12. The apparatus of claim 11, further comprising:
a file generator to generate a file by combining a decoded data of the recorded data packets from the media decoders; and
a secured storage location having a controlled accesses to store the file.

13. The apparatus of claim 12, wherein the secured storage location is a media mailbox.

14. A method comprising:
sending a command by a remote station to record at a server of a wireless communication system a conversation of the remote station with other remote stations by alternating between a first media recorder to a second media decoder; and
storing at a storage medium of the server data packets comprising a media content of the conversation.

15. The method of claim 14, further comprising:
sending a command by the remote station to the server to play a recorded media content of the conversation at the remote station;
decoding at the server the recorded media content by alternating between the first media decoder to the second media decoder; and
transmitting by a base station a modulated decoded media content of the conversation to a commanding remote station.

16. The method of claim 15, further comprising:
providing to a subscriber of a recording service a media mailbox to store the recorded media content of the conversation; and
retrieving by the remote station a recorded conversation by accessing the media mailbox.

17. An article comprising a storage medium having stored thereon instructions, that, when executed by a computing platform, results in:
sending data packets of a recorded conversation from a first and a second remote stations to a subscriber, wherein a conversion recording is done by alternating between a first link to a second link and storing data packets comprising a media content of the recorded conversation at a storage medium.

18. The article of claim 17, wherein the instructions result in:
decoding a recorded media content by alternating between a first media decoder and to a second media decoder; and
sending a decoded media content of the recorded conversation to a subscriber which is an originator of the conversation recording.

19. The article of claim 18, wherein the instructions result in:
generating a file which includes data packets comprising the recorded media content of the conversation; and
storing the file at a secured location having a controlled access.

20. The article of claim 19, wherein the instructions result in:
receiving a command for sending the file via a global network to a computer; and
storing the data packets comprising the recorded media content of the conversation at a storage medium.
